(19) United States
(12) Patent Application Publication
(10) Pub. No.: US 2008/0120559 A1
(43) Pub. Date: May 22, 2008

(54) SWITCHABLE USER INTERFACES

(75) Inventor: Dawson Yee, Bellevue, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/561,340

(22) Filed: Nov. 17, 2006

(51) Int. Cl. G06F 3/048

(52) U.S. Cl. 715/764

(57) ABSTRACT

Facilities are provided for adapting the user interface functionality of devices based on a configuration of the user interface components. In various embodiments, a facility includes a communication device that provides switchable user interface functionality by receiving a user interface component, detecting a type associated with the user interface component, recognizing the type associated with the user interface component, and loading user interface functionality associated with the recognized type. A communication device can be a part of a communication system that includes the communication device and a user interface component removably attached thereto.

### BACKGROUND

Despite the tremendous diversity of electronic and electromechanical devices such as telephones, microwave ovens, automated teller machines (ATMs), etc., there has been little innovation in the user interfaces associated with these devices in recent years. For example, these devices are conventionally preconfigured at a factory with a particular user interface and a predefined user interface functionality. The user interface of a device is a portion of the device that enables a user to interact with or control the device. As an example, a user interface often associated with telephones, microwave ovens, and ATMs is a keypad. User interface functionality defines how the device responds to the user's interactions with the user interface. As an example, the user interface functionality associated with pressing a key on a keypad may include displaying information on a display component associated with the user interface and taking an action.

User interfaces can include buttons, switches, dials, displays, and so forth. The user interface typically receives input from users and/or provides output to users. As examples, telephones and ATMs have buttons that enable users to make selections. Some ATMs and telephones, such as Voice over Internet Protocol (VolP) telephones, may additionally have a display that provides visual output to the user, such as on a liquid crystal display (LCD), cathode ray tube (CRT), or other type of display. Such displays may include “touchscreen” functionality that enables users to make selections by touching an appropriate region of the display.

Manufacturers sometimes manufacture different product models that are based on a common underlying platform. As an example, a manufacturer may produce multiple product models that implement different user interfaces. When these user interfaces enable different functionality, a portion of the electronic device corresponding to the implemented user interface may also need to change. As an example, when the user interface provides no physical buttons to enable entry of numbers (e.g., phone numbers), the display may need to enable selection of numbers, such as by providing virtual buttons with numbers. To change the functionality provided by electronic devices, manufacturers conventionally modify the electronic device, such as by changing configuration switches, replacing or reprogramming firmware or software, and so forth. Thus, customization of electronic devices can become expensive or time-consuming.

### SUMMARY

Facilities are provided for adapting the user interface functionality of devices based on a configuration of the user interface components. A device can receive one or more user interface components, detect the type of the received components, and adapt the user interface functionality based on the received components. The user interface component can be a portion of the user interface that is easily installed, such as during manufacture, distribution, or sales. Even a user can install a user interface component in some embodiments. As an example, the user interface component can be attached to a portion of the device that users can employ.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIGS. 1-3 are exploded front isometric views of electronic devices in accordance with some embodiments.

FIG. 4 is a block diagram illustrating components associated with electronic devices in various embodiments.

FIG. 5 is a flow diagram illustrating a routine invoked by the facility in some embodiments.

FIG. 6 is a flow diagram illustrating a routine for enabling reconfiguration of a device in some embodiments.

FIG. 7 is a partial cross-sectional side view of a keypad membrane that can be employed with a user interface component in some embodiments.

### DETAILED DESCRIPTION

Facilities are provided for adapting user interface functionality of devices based on a configuration of the user interface components. In various embodiments, a device can receive one or more user interface components, detect the type of the received components, and adapt the user interface functionality based on the received components. The user interface component can be a portion of the user interface that is easily installed, such as during, for example, manufacture, distribution, or sales. Even a user can install a user interface component in some embodiments. As an example, the user interface component can be attached to a portion of the device that users can employ. Examples of devices that can receive such user interface components include communications devices, ATMs, and indeed many if not all electronic or electromechanical devices that have user interfaces.

In various embodiments, a user interface component is a thin “faceplate” that can be removably attached to the device, such as by sliding the faceplate into position, snapping it into position, and so forth. The faceplate may cover a portion of the device or the entire device. In some embodiments, the faceplate covers a user interface portion of the device. In some embodiments, the faceplate can be the housing for the device.

Each user interface component can be manufactured to provide a different configuration of keys, buttons, dials, etc. Each such configuration is a “type” of user interface component and the user interface component is identified by its type. The user interface component is able to communicate its type to the device with which it operates. As examples, the user interface component can communicate its type to the device via a wired connector or wirelessly, such as by using radio frequency identification (“RFID”) or other wireless communications means. In some embodiments, the user interface component communicates its type to the device with which it operates when queried by the device. As an example, the device can send a signal to a user interface component that is attached to the device and, in response, the user interface component responds with its type.

The device detects the type of user interface components it receives, such as through a wired port or by wireless communications. Upon detecting the type, the device can load user interface functionality associated with that particular type of user interface component. As examples, the device can load the functionality from a memory associated with the facility. The memory can be located within the device housing, or it can be located at another device with which the device is capable of communicating. In various embodiments, the device may determine whether the user interface functionality associated with the type of user interface component it receives can be loaded from memory and, if not, attempt to load the user interface functionality from a networked device via, for example, an intranet or the Internet. The device can then operate according to the loaded user interface functionality.

In some embodiments, the device is a Voice over Internet Protocol phone that can exchange VolP messages with other devices. The VolP phone can have a user interface with a display area and a keyboard area. The display area can include a “touchscreen.” The keyboard area can accommodate different user interface components. Examples of user interface components for a VolP phone can include standard 4×3 telephone keys (e.g., indicating numerals 0-9 and symbols # and *), as commonly employed on conventional telephones, and programmable “soft keys” for storing commonly dialed locations and enabling features such as hold, conference calling, speakerphone, and so forth. As an example, a manufacturer may provide two types of user interface components: user interface component type A may provide standard 4×3 keys, whereas user interface component type B may not provide standard 4×3 keys. When the VolP phone receives a user interface component (types A or B), it loads user interface functionality relating to that user interface component. The VolP phone may also be preconfigured with the functionality associated with user interface component type B. This can be referred to as a default configuration. With this functionality, the touchscreen may provide “soft” 4×3 keys whether or not the VolP phone is configured with standard 4×3 keys. When a user touches locations of the touchscreen corresponding to these keys, the device acts as if the user had pressed similar physical keys. Thus, this default behavior may be provided whether the VolP phone receives user interface component type B or not. When the VolP phone receives user interface component type A, it may load the corresponding user interface functionality from its memory or from the memory of another device located on the network, such as a server. Because user interface component type A provides the 4×3 keys, its user interface would not need to also provide the 4×3 keys on the touchscreen. Instead, it may provide access to other phone functionality. Alternatively, it may provide 4×3 keys both physically in the keyboard area as well as virtually in the display area. The manufacturer may thus market two different models of phones without the expense of actually building two different types of phones.

Thus, in various embodiments the facility enables a manufacturer to easily adapt devices according to different needs. A manufacturer of a device can provide different user interfaces for the device. As an example, a manufacturer of a VolP phone may customize the user interface to provide multiple models without bearing the expense of manufacturing several different housings, user interfaces, and so forth. The manufacturer can provide customers with their choice of user interfaces. For example, a customer may purchase a single type of phone for use by engineers and executives but change the functionality provided by the phones by installing a first user interface component type for use by the engineers and a second, different user interface component type for use by the executives.

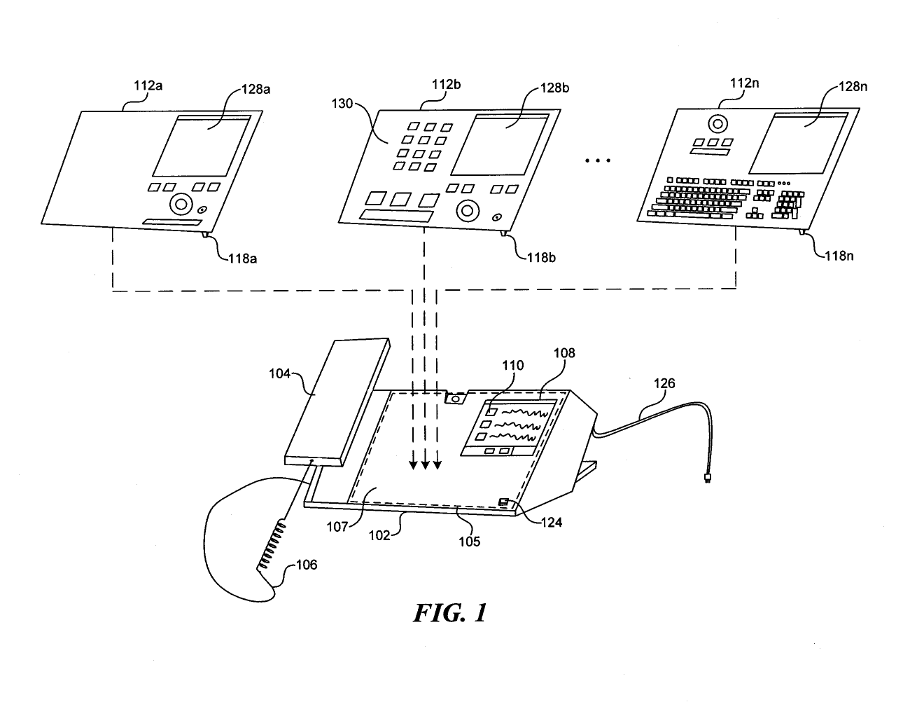

The facilities will now be described with reference to the figures. FIGS. 1-3 are exploded front isometric views of modular electronic systems (e.g., modular communication systems) in accordance with some embodiments. According to the embodiment illustrated in FIG. 1, a device (e.g., a VolP telephone) 102 has a handset 104 that is connected to the device 102 via, e.g., a wire 106. The handset 104 can also be a wireless handset. The device 102 has a user interface area 105 including a keyboard area 107 and a display area 108. The display area 108 can include a plurality of keys 110, which can be virtual keys displayed within the display area 108 or physical keys attached to the device 102 or to user interface components 112a-112n.

The device 102 can be compatible with, and receive, a plurality of different user interface components, such as components 112a-112n. Each user interface component 112 may have various keys, buttons, dials, etc., as is illustrated. As an example, user interface component 112b has a set of 4×3 keys 130. The user interface components can also have apertures 128a-128n to enable a user to view or access the display area 108. The apertures 128a-128n may optionally be covered by a clear plastic or another transparent material.

The device 102 may have one or more connectors 124 that interface with corresponding connectors associated with user interface components 112a-112n. As examples, user interface component 112a has connector 118a, user interface component 112b has connector 118b, and user interface component 112n has connector 118n. Although the illustrated embodiment shows a female connector 124 on the device 102 and corresponding male connectors on the user interface components 112a-112n, the respective orientations of the connectors could be reversed. In various embodiments, the connectors may make contacts without male or female ends. In various embodiments, the connection can be a wireless connection. For example, the user interface components 112a-112nmay have RFID chips and the device may have an RFID transponder or vice versa. The device 102 can receive type information about the user interface component and user inputs (e.g., key selections or other input) via the connectors 124/118a-118n. In various embodiments, the device 102 and user interface components 112a-112n may have multiple connections. As an example, the device 102 may query the user interface component for its type via a first connection but receive user input via a second connection.

The device 102 may connect to one or more networks (not shown) via, e.g., a network connection cable 126. The network connection can employ digital or analog networks, such as Ethernet, telephone, etc. The network connection can also be wireless, such as over IEEE 802.11, infrared, Bluetooth, etc. The device 102 may use the network connection to load user interface functionality. The device 102 can also use the network connection to enable communications. As an example, a Vol P telephone may use an Ethernet or IEEE 802.11 connection to enable voice or video conversations. The device may also connect to the network via a computer (not shown), such as by using a universal serial bus (USB), serial communications port, parallel communications port, wireless network adapter, Ethernet network adapter, and so forth.

Although a telephone-type device is shown in FIG. 1 for purposes of illustration, various aspects of the present disclosure can also be incorporated in facsimile machines, microwave ovens, ATMs, or any other electronic or electromechanical device that includes a user interface. Accordingly, in various embodiments, the device may not include a handset.

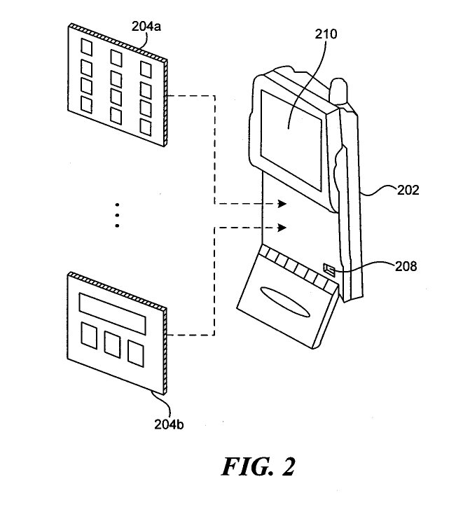

In the embodiment illustrated in FIG. 2, a mobile device 202 (e.g., a mobile or cellular telephone) can receive one or more user interface components, such as components 204a and 204b. These components can provide keys, buttons, dials, etc., that a user can employ to provide input to the mobile device 202.

The mobile device 202 may have one or more connectors 208 to interface and/or communicate with the user interface components 204a-204b when they are attached to the device 202. In operation, the connector 208 can identify the type of interface component, receive user input, and so forth.

The devices may also have one or more display areas 210, such as to provide output to a user. The display areas 210 may also receive user input via, e.g., a touchscreen. Examples of touchscreens include those employed by handheld computing devices (e.g., MICROSOFT POCKET PC), tablet computing devices, etc. Such touchscreens may receive input via a finger or electromechanical device, such as a stylus.

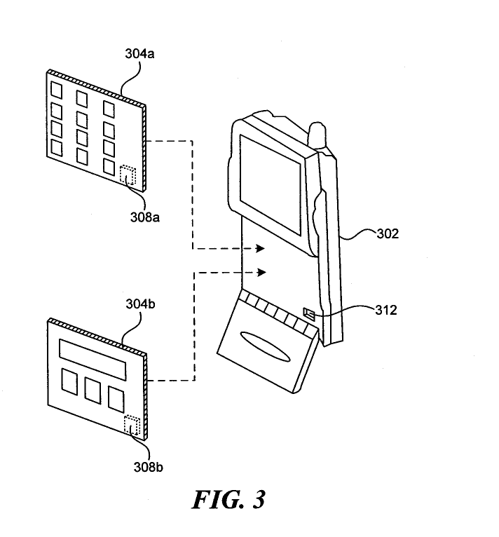

In the embodiment of FIG. 3, a mobile device 302 can receive input from a plurality of different user interface components (e.g., components 304a or 304b) via one or more connectors 312 associated with the mobile device 302. The user interface components 304a-304b may also have one or more connectors, such as connectors 308a or 308b, which cooperate and/or interface with the connectors 312. The connectors 308a-308b and 312 can be physical or wireless connectors. As an example, the mobile device 202 may employ wireless connectors to interface and/or communicate with the user interface components 204a-204b, but mobile device 302 may employ physical connectors 308a-308b.

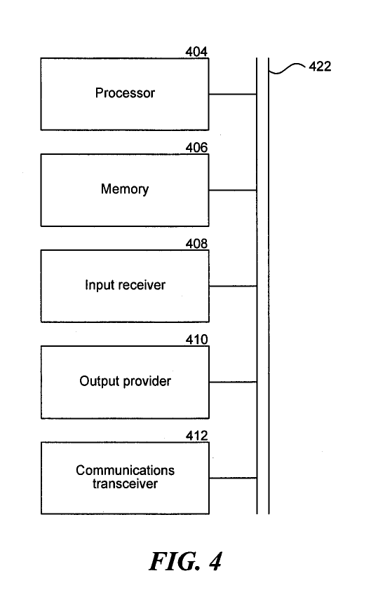

FIG. 4 is a block diagram illustrating components associated with an electronic or electromechanical device, such as the devices 102, 202 and 302 described above, in various embodiments. The device may have components such as a processor 404, memory 406, input receiver 408, output provider 410, and communications transceiver 412. The processor 404 can be any commonly employed processor. The processor 404 can analyze input to determine output, such as to provide user interface functionality based on a user interface component's type. The processor 404 can also process input that is received, such as to handle communications, and provide output. The memory 406 can be flash memory, various types of random access or read-only memory, secondary storage such as in a disk, etc. The input is received via the input receiver 408 and the output is provided via the output provider 410. The input receiver 408 can receive input from a display, such as the display areas 108 or 210 described above, a user interface component, such as the user interface components describe above, and so forth. As an example, the input receiver 408 can receive input from a connector, e.g., that connects the device with a user interface component connector, e.g., 118a-118n, 308a-308b, etc. The output provider 410 provides output to the display, user interface component, and so forth. The communications transceiver 412 handles communications with a network, such as to enable telephone or video communications. As an example, the communications transceiver 412 may handle VolP or session initiation protocol (SIP) messages, such as by using transport control protocol/Internet protocol (TCP/IP). The components 404, 406, 408, 410 and 412 may connect to each other over a bus 422, such as to transfer input or output, make requests to the processor, communicate with components not illustrated, etc.

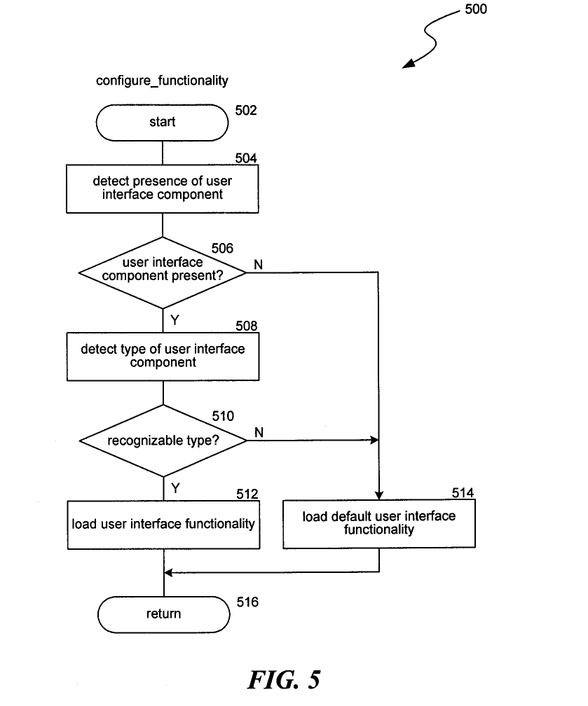

FIG. 5 is a flow diagram illustrating a routine 500 invoked by the facility in some embodiments to configure user interface functionality. The device (e.g., one or more of the devices 102, 202 or 302 described above) may invoke the routine 500 when it starts up, detects that it has received a user interface component, or at other times. The routine 500 begins at block 502. At block 504, the routine 500 detects the presence of a user interface component. As an example, when a user interface component is attached to a device, a switch in the device may be closed or opened to indicate the presence of the user interface component. Alternatively, the device may detect the presence of the user interface component through other means. At decision block 506, the routine 500 determines whether a user interface component is detected. When a user interface component is detected, the routine 500 continues at block 508. Otherwise, the routine 500 continues at block 514.

At block 508, the routine 500 detects the type of user interface component that is attached. As an example, the routine can detect the type of user interface component by querying the user interface component via, e.g., a physical or wireless connector. At decision block 510, the routine 500 determines whether the user interface component type provided by the user interface component is recognizable. As an example, the routine may check a table of user interface component types stored in a memory associated with the device. When the type is recognizable, the routine 500 continues at block 512. Otherwise, the routine 500 continues at block 514. In some embodiments, such as when the user interface component type is not stored in memory directly associated with the device, the routine 500 may check a different memory, e.g., memory associated with a server computing device or other repository, to determine whether information about the type is stored in the server's memory. The routine may perform this step so that a default user interface functionality is not loaded, such as at block 514. The server's memory can be a primary or secondary storage.

At block 512, the routine 500 loads user interface functionality associated with the defected type of user interface component. The routine 500 may load user interface functionality from a memory associated with the device or a remote memory. As an example, when the user interface functionality is not stored in device memory, the routine may load it from a server computing device. At block 514, the routine 500 loads a default user interface functionality, such as from the device memory. The default user interface functionality may provide device features when a user interface component is not installed or when the device does not recognize the installed user interface component. The routine 500 then continues at block 516, where it returns.

Those skilled in the art will appreciate that the logic illustrated in FIG. 5 and in the flow diagram discussed below may be altered in various ways without departing from the scope of the present disclosure. For example, the order of the logic may be rearranged, substeps may be performed in parallel, shown logic may be omitted, and/or other logic may be added, etc.

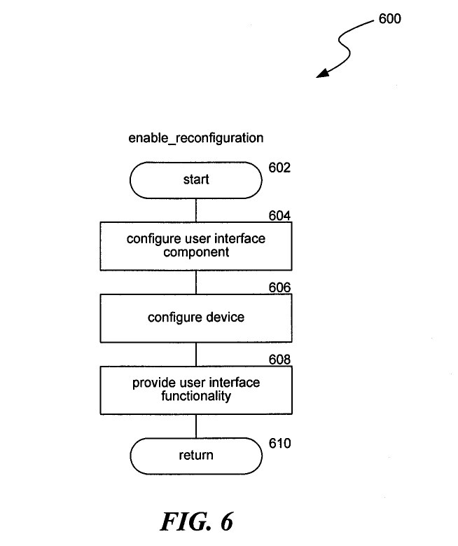

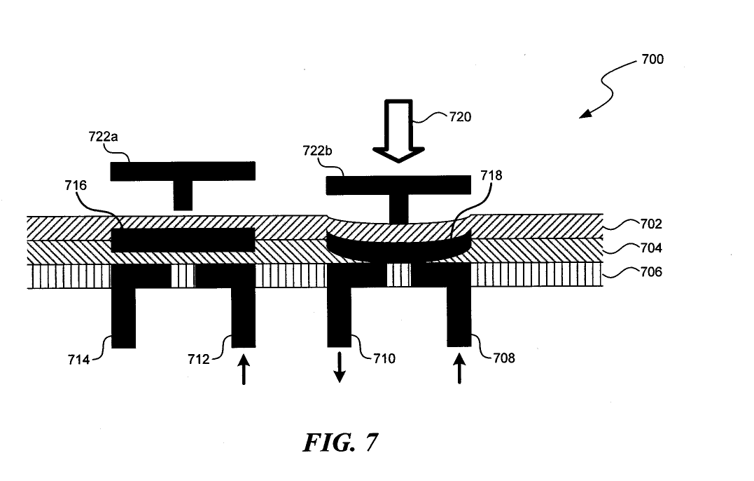

FIG. 6 is a flow diagram illustrating a routine 600 for enabling reconfiguration of a device in some embodiments. The routine 600 may be partially performed during a manufacturing, distribution, or sales process. The routine 600 may also be partially performed by a user, such as when the user is attaching a user interface component to the device. The routine begins at block 602. At block 604, a user interface component is configured, such as by adding or removing keys, adding a keypad membrane, assigning a user interface component type, etc. Keypad membranes are discussed in further detail below in relation to FIG. 7. In some embodiments, each assigned user interface component type may be unique so that the device can readily distinguish types.

At block 606, the device is configured, such as by adding the assigned user interface component type to a location, such as a table, in device memory. The user interface component type may also be added to memory in a server instead of or in addition to the device memory.

At block 608, the user interface functionality associated with the user interface component is added, such as to the device memory or a server memory. At block 610, the routine returns.

FIG. 7 is a partial cross-sectional side view of a user interface component keypad membrane 700 in accordance with some embodiments. The keypad membrane 700 can be employed as a portion of a user interface component. The user interface component can include a keypad membrane 700, e.g., for providing keys (not shown in detail in the Figure). The keypad membrane 700 can include multiple layers. For example, a first layer 702 can be a layer that the user can interact with, such as by applying a force 720 to a key 722a or 722b. A second layer 704 can be an insulating layer. A third layer 706 can include conducting elements, such as conducting elements 708, 710, 712, and 714. The first or second layer may also include connecting surfaces, such as surfaces 716 and 718, that include a conductive portion. When a user presses a key 722b, such as by applying pressure 720, the connecting surface 718 closes a circuit between elements 708 and 710, causing current to flow from element 708 to element 710 via element 718. In contrast, because no pressure is applied to connecting surface 716, current does not flow from element 712 to element 714. The pressure 720 can be applied directly to the first layer 702, or it can be applied via a suitable form of physical key 722b. The keypad membrane 700 can also include a component (e.g., a microchip, connector, transponder, etc.) that is capable of communicating the type of the user interface component. Thus, user interface components can be quite thin and can be incorporated into a removable faceplate.

In various embodiments, the connectors between user interface components and devices may also provide output from the devices to the connectors, such as to provide power to a light (such as a key backlight), change labels on keys, buttons, dials, etc., and so forth.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited, except as by the appended claims.

I claim:

1. A modular communication system, comprising:
a communication device, the communication device including:
a processor associated with a memory, wherein the memory stores a first user interface functionality associated with a first type of user interface component and at least a second user interface functionality associated with a second type of user interface component; and
a user interface component removably attached to the communication device, wherein the processor detects the type of the user interface component and implements the first user interface functionality when the user interface component is detected to be the first type of user interface component, or the second user interface functionality when the user interface component is detected to be the second type of user interface component.

2. The modular communication system of claim 1 wherein the communication device includes a first connector and the user interface component includes a second connector, and wherein the second connector is releasably engaged with the first connector to enable the processor to detect the type of the user interface component.

3. The modular communication system of claim 1 wherein the processor loads the first user interface functionality from the memory when the processor detects that the user interface component is the first type of user interface component.

4. The modular communication system of claim 1 wherein the memory is located on a server computing device and associated with the processor via a network.

5. The modular communication system of claim 2 wherein the communication device further includes a display, and wherein the processor provides a visual portion of the first user interface functionality on the display when the processor detects that the user interface component is the first type of user interface component.

6. The modular communication system of claim 3 wherein the display portion comprises a touchscreen.

7. The modular communication system of claim 2 wherein the first and second connectors are wired connectors.

8. The modular communication system of claim 2 wherein the first connector is an RFID transceiver and the second connector is an RFID chip.

9. The modular communication system of claim 1 wherein the memory is flash memory.

10. The modular communication system of claim 1 wherein the communication device further includes a network connection operably connecting the communication device to another communication device via a digital communications protocol capable of carrying voice information.

11. The modular communication system of claim 10 wherein the network connection is an Ethernet connection.

12. The modular communication system of claim 1 wherein the communication device further includes a communications transceiver.

13. The modular communication system of claim 12 wherein the communications transceiver processes Voice over Internet Protocol messages.

14. The modular communication system of claim 1 wherein the communication device further includes a connection to a computing device.

15. A method performed by a communication device for providing user interface functionality, comprising:
receiving a user interface component;
detecting a type associated with the user interface component, wherein the type can be one of a plurality of different types;
recognizing the type associated with the user interface component; and
loading user interface functionality associated with the recognized type.

16. The method of claim 15, further comprising providing the loaded user interface functionality to a user.

17. The method of claim 16 wherein the providing includes displaying a portion of the user interface on a display associated with the communication device.

18. The method of claim 17, further comprising receiving input from the user via the user interface component.

19. The method of claim 15 wherein when the type cannot be recognized, loading default user interface functionality.

20. A system for providing user interface functionality, comprising:
a first user interface component and a second user interface component, the first user interface component associated with a first user interface feature and the second user interface component associated with a second user interface feature; and
a processor component that receives a signal indicating that the first user interface component was received and provides the first user interface feature but not the second user interface feature.
